(19) United States
(12) Patent Application Publication
(10) Pub. No.: US 2008/0311241 A1
(43) Pub. Date: Dec. 18, 2008

(54) Breadmaking Improver

(75) Inventors: Laurent Soupiron, Marquillies (FR); Nigel Saunders, Marcq en Baroeul (FR); Pascal Lejeune, Tourcoing (FR)

Correspondence Address: SUGHRUE MION, PLLC, 2100 PENNSYLVANIA AVENUE, N.W., SUITE 800, WASHINGTON, DC, 20037, US

(73) Assignee: LESAFFRE ET COMPAGNIE, Paris (FR)

(21) Appl. No.: 12/096,695

(22) PCT Filed: Dec. 12, 2006
(86) PCT No.: PCT/FR06/51335

§ 371 Date: Jun. 9, 2008

(30) Foreign Application Priority Data
Dec. 13, 2005 (FR) 0512610

(51) Int. Cl. A21D 8/04; A21D 2/08

(52) U.S. Cl. 426/18; 426/62; 426/61

(57) ABSTRACT

The present invention relates to a novel breadmaking improver comprising a preferment which is acidic and an acidity regulator, and also to the use thereof in a process for preparing a baker's dough for baking which contains this improver.

The present invention relates to a baking improver, and to its use in a process for preparing a baker's dough for baking containing this improver.

The use of glucono-delta-lactone (GDL) in baking has been known for a long time for its acidifying effect in the dough.

In GB-A-2339134, it has been proposed to use GDL in combination with a chemical leavening agent and a preservative in the preparation of a dough. Chemical leavening agents are mixtures of acidic and alkaline reactive compounds which react slowly to form CO₂. Although preservatives are used in the preservation of foods prepared with chemical leavening agents, the supplementary addition of pH-reducing substances which make it possible to increase the efficacy of any preservative proportionally reduces the efficacy of the chemical leavening agent because of the interactions between the pH-reducing substances and the alkaline reactive compounds of the chemical leavening agent. GB-A-2339134 teaches a means which makes it possible to reduce the pH and to thereby increase the efficacy of the preservatives and therefore the preservation of foods without affecting, as a result, the efficacy of the chemical leavening agent. This prior art document teaches in particular the use of GDL in combination with a chemical leavening agent and a preservative, such as an acidic reagent intended to reduce the pH in order to increase the efficacy of the preservative without affecting the alkaline reactive compound of the chemical leavening agent. GDL is used as an ingredient for the preservative in order to increase the percentage of undissociated acid in the preservative, thereby increasing its efficacy and, consequently, the storage life of the product.

It has also been proposed in EP-A-0815731 to use GDL as acid-generating agent for the production of a fermented sourdough. This prior art document describes the hydrolysis of GDL in an aqueous medium in order to generate gluconic acid, it being possible for this hydrolysis to occur, for example, by virtue of the water present in the unfermented sourdough.

It is also known to use dry leaven flours, also called dehydrated fermented flours, in baking. The addition of these dehydrated fermented flours to the dough offers an improvement in the organoleptic qualities and a better preservation of the baked product. These fermented flours, obtained by dehydration or drying of a leaven, no longer contain active microorganisms, but they still contain a large part of the flavours formed during the fermentation of the leaven by the lactic acid bacteria in leaven and preferably also the yeasts in the leaven. These flavours are mainly lactic acid, but also the other flavours from the leaven fermentation. Their use in particular offers the baked product an acidic flavour which is greatly appreciated in some categories of baked products. However, the incorporation of a dehydrated fermented flour into the dough is not without disadvantages. It has in particular a significant effect on the rheology of the dough. It is indeed observed that kneading becomes difficult: the formation of the gluten network, which is necessary for the retention of the CO₂ produced by the yeast, is slower or even incomplete. The doughs are both strong and porous, causing problems during moulding, and then on the loaves which are less attractive and less voluminous. Furthermore, the acidity present penalizes the fermentative action of the yeast which, as a result, will produce less gas, finally giving bread of smaller volume.

Likewise, the addition of an acid and/or of an acid salt to the dough results in the same rheological problems as those encountered during the use of dry leavens.

It has been observed, surprisingly, that it is possible to reduce, or even avoid the disadvantages linked to the use of acids and/or of acid salts in a dough by the addition of glucono-delta-lactone (GDL). In particular, the present invention shows that it is possible to have the benefit of the advantages linked to the use of a fermented sour flour and to reduce, or even avoid, the rheological problems observed both on the dough, but also on the bread product obtained by baking the said dough, by the use of a combination of a fermented sour flour and glucono-delta-lactone (GDL). It has also been observed that the present invention offers a benefit on the rheological properties of the dough but also of the bread product obtained by baking the said dough by the use of a combination of a dry, liquid or pasty leaven and of GDL.

The present invention relates to a baking improver comprising an acid and/or an acid salt in combination with glucono-delta-lactone. In one particular embodiment, the improver consists of an acid and/or an acid salt and glucono-delta-lactone. Preferably, the acid and/or the acid salt is an acid preferment.

The expression “acid preferment” is understood to mean a product generating or containing one or more acids chosen from the group comprising edible organic acids, combinations of the said acids, the edible salts of the said acids, combinations of the said salts and combinations of one or more of the said acids with one or more of the said salts, and obtained by fermentation of a substrate containing flour by means of a biomass, the said biomass containing at least one bacterium capable of producing, by fermentation, at least one or more acids and/or their corresponding salts. The acid preferment according to the invention may in particular comprise at least one component chosen from the group consisting of lactic acid, lactic acid salts, acetic acid, acetic acid salts, propionic acid, propionic acid salts, benzoic acid, benzoic acid salts, sorbic acid and the edible salts of sorbic acid, and combinations thereof, in particular combinations of either one and/or several other of the acids, or either one and/or several other of the salts or of either one and/or several other of the acids and salts.

The preferment according to the invention may advantageously comprise one of the components chosen from the group consisting of lactic acid, lactic acid salts, acetic acid, acetic acid salts and combinations thereof.

In the present context, the term “acid preferment” refers to the dry, pasty or liquid leavens, as defined below.

According to a preferred embodiment of the invention, the acid preferment of the improver according to the present invention may be a dry leaven. The dry leaven corresponds to a dry product obtained by drying a dough fermented by means of microorganisms belonging to the bacteria of bread leavens and possibly of yeasts of bread leavens. The bacteria of bread leavens are described in particular in Chapter 4.2 of the reference book “Handbuch Sauerteig—Biologie—Biochemie—Technologie” by Spicher and Stephan, 4th edition (ISBN 3-86022-076-4). Dry leaven is also marketed under the French trade names: “farine fermentée, farine fermentée déshydratée, farine préfermentée, levain déshydraté”, under the English trade names: dry or dried sourdough, dry or dried leaven or levain, dry or dried fermented flour, dry or dried prefermented flour, sourdough concentrate, sourdough powder, and sour flour, and under the German names “Trockensauer” and “Sauerteigpulver”. The dry leaven present in the improver according to the invention may be obtained from a fermented dough comprising one or more cereal(s) flour(s), comprising one or more flour(s) derived from a bran-rich mill product or comprising a combination of one or more cereal(s) flour(s) with one or more flour(s) derived from a bran-rich mill product, it being possible for this dough to also contain cereal germs. Preferably, the dry leaven is derived from a fermented dough comprising wheat flour and/or rye flour, one or more flour(s) derived from a bran-rich mill product obtained from wheat and/or one or more flour(s) derived from a bran-rich mill product obtained from rye or a combination of wheat flour(s) and/or of rye flour(s) with one or more flour(s) derived from a bran-rich mill product and obtained from wheat and/or rye. The dough may also contain ground wheat germs.

These dry leavens obtained by dehydration or drying no longer contain active microorganisms, but they still contain a large part of the flavours formed during the fermentation of the leaven by the bacteria of the leaven and possibly also the yeasts of the leaven, these flavours being mainly lactic acid, but also the other flavours from the leaven fermentation.

The dose of lactic acid in the dry leaven is advantageously greater than or equal to 50 g per kg of dry leaven, and more advantageously at least 70 g per kg of dry leaven, and more advantageously still at least 100 g per kg of dry leaven.

According to another preferred embodiment of the invention, the acid preferment of the improver according to the present invention may be a liquid leaven, such as for example a leaven as described in EP 0953 288 and WO 2004/080187.

According to one embodiment, the liquid leaven according to the invention consists of a flour-based culture medium containing at least one cereal flour and water, the said culture medium being inoculated and fermented with a selection of microorganisms which may advantageously comprise lactic acid bacteria. The said microorganisms are capable of synthesizing one or more acids chosen from the group comprising edible organic acids, the edible salts of the said acids and combinations thereof, in particular combinations of the said acids, of the said organic salts or of one or more of the said acids with one or more of the said organic salts. In the present context, the expression “flour-based culture medium” denotes a culture medium whose dry matter content has, as main ingredient, one or more cereal flours. The liquid leaven according to the invention contains at least 7 g/l of acetic acid, and optionally lactic acid. The liquid leaven according to the invention has a pH of between 3.8 and 4.5.

According to another embodiment, the liquid leaven according to the invention consists of milk or its derivatives fermented by microorganisms and containing organic acids and/or their salts.

According to another preferred embodiment of the invention, the acid preferment of the improver according to the present invention may be a pasty leaven. A pasty leaven is for example a leaven as defined in Chapter 10 in the book by Raymond Calvel “The taste of bread”, Aspen Publishers, Inc., Gaithersburg, Md., 2001, ISBN No.: 0-8342-1646-9.

The acid and/or the acid salt of the baking improver is any acid and/or acid salt which has a capacity to improve baking. This capacity may be an acidifying, preserving, antioxidant, thickening or gelling capacity. For example, and without being limited to this list, the said acid and/or acid salt may be or may comprise at least one component chosen from the group consisting of sorbic acid, sorbic acid salts, propionic acid, propionic acid salts, acetic acid, acetic acid salts, lactic acid, lactic acid salts, malic acid, malic acid salts, citric acid, citric acid salts, ascorbic acid, ascorbic acid salts, alginic acid, alginic acid salts, benzoic acid, benzoic acid salts and combinations thereof. The salts are preferably edible salts. For example, the acid salts may be the following: potassium sorbate, calcium sorbate, potassium propionate, calcium propionate, sodium propionate, potassium acetate, calcium acetate, sodium acetate, potassium lactate, calcium lactate, sodium lactate, potassium malate, calcium malate, sodium malate, potassium citrate, calcium citrate, sodium citrate, ammonium citrate, sodium ascorbate, calcium ascorbate, sodium alginate, potassium alginate, ammonium alginate, calcium alginate.

The present invention has the advantage of obtaining bread prepared from a dough containing an acid and/or acid salt, preferably an acid preferment, and having nevertheless a good rheological quality because of the presence of GDL. The structure of bread, also called crumb structure, is linked to the capacity of the gluten in the flour to create a three-dimensional molecular network capable of retaining the gas produced by the yeasts during fermentation. This network is only produced by virtue of the formation of disulphide bridges between the macromolecules which constitute the gluten (gliadins and glutenins), rich in cysteine. The energy necessary for the formation of these disulphide bridges is provided by the mechanical action of the kneading and almost exclusively by it. On the other hand, once formed, this network is particularly resistant, the disulphide bridges being strong bonds. The quality of this network, and its capacity to retain the gas generated by the yeast, allows raising of the dough and the characteristic structure of the crumb. It is therefore essential that nothing disrupts the formation of the gluten network during kneading. However, the acids and/or their salts penalize the formation of the disulphide bridges. As a result, the doughs are soft, sticky and the breads are flat. By virtue of the use of GDL, these rheological problems may be reduced or even eliminated. Thus, the acids and/or acid salts, in particular the acid preferments, may be used without having the rheological problems pertaining to their use.

In baking, it is common to express the quantities of ingredients present in the dough as so-called “baker's” percentages. The baker's percentage is a method of calculation in which the total mass of flour present in the baker's dough formula, that is to say in the final dough, always represents 100% and the mass of the other ingredients is calculated relative to this flour base. In the calculation of the baker's percentages, only the flour in the strict sense, in general wheat flour obtained from the mill, is taken into account as quantity of flour adjusted to 100. The flour entering into the fermented cereal flour and constituting the acid preferment, regardless of the cereal or cereals, is not taken into account in the calculation, and likewise the wheat gluten, which is of course vital gluten.

Unless otherwise stated, in the description of the invention below, the quantities of the ingredients of the baker's dough are expressed as baker's percentages.

The present invention relates in particular to a solid baking improver comprising an acid and/or acid salt, preferably an acid preferment, in combination with glucono-delta-lactone and having a dry matter content of at least 85% by mass. The improver may in particular have a dry matter content greater than or equal to 90% by mass, and preferably still greater than or equal to 94% by mass.

The preferred form of the improver according to the present invention is the dry form. According to a more preferred form, the dry form may be pulverulent or in the form of granules. The granular form has the advantage of being less dusty and of having a lower tendency to become dispersed in the air. The mean diameter of the particles of the improver is preferably between 50 μm and 300 μm, more preferably between 80 μm and 150 μm and more preferably between 80 μm and 120 μm.

According to one embodiment of the invention, the improver may also be liquid, pasty or semi-moist according to its dry matter content.

According to a preferred mode of the present invention, the GDL is packaged in the form of a mixture with the acid preferment.

According to another preferred embodiment of the present invention, the acid preferment is separated from the GDL during its preservation. One of the means of separation is the separate packaging of the GDL. In this case, the incorporation is made either simultaneously by mixing the GDL with the acid preferment before addition to the kneader, or separately by adding each of the two constituents individually. Thus, the present invention also relates to a combination comprising an acid preferment and glucono-delta-lactone used simultaneously or separately over time as baking improver. When the acid preferment and the glucono-delta-lactone are introduced separately over time, the period of time separating the incorporation is adjusted so that the GDL can act on the rheological disadvantages of the acid preferment.

Another means of separation is to encapsulate the GDL in order to maintain its functional properties up to its action in the dough. Two types of encapsulation processes can be used:
physicochemical processes such as for example coacervation, evaporation of solvent,
mechanical processes such as, for example, fluidized bed, hot or cold nebulization, extrusion and centrifugation.

All the food-compatible encapsulation carriers may be envisaged for the encapsulation of GDL, such as for example:
carbohydrates: maltodextrins, modified starches, cyclodextrins, sucrose, cellulose . . . ;
gums: algae extracts, gum arabic, guar . . . ;
lipids: hydrogenated or nonhydrogenated vegetable or animal fat, waxes, lecithins . . . ;
proteins: gelatin.

According to a particularly preferred embodiment, the fluidized bed coating technique is used. It consists in spraying a coating product over solid particles fluidized in an airstream. A wide variety of coating products may be used: cellulose derivatives, dextrins, emulsifiers, lipids, protein derivatives, modified starches.

When the improver is in liquid, pasty or semi-moist form, the coating is not water-soluble, and the release of GDL occurs through a mechanical action during kneading of the dough.

When the improver is in the dry form, all the encapsulation and coating carriers may be envisaged.

Preferably, in the present invention, GDL is used between 0.05 and 5%, preferably still between 0.1 and 3% and preferably still between 0.1 and 1.5% as baker's percentages.

The improver according to the invention may also comprise one or more ingredients having an improver effect, and in particular one of more ingredients chosen from the group consisting of ascorbic acid, emulsifiers, stabilizers-thickeners and enzymes. The improver according to the invention may thus comprise one or more ingredients having an improver effect, such as:
ascorbic acid,
L-cysteine or deactivated yeast,
stabilizers-thickeners, such as:
   pregelatinized flour, modified starches,
   CMC (carboxymethylcellulose),
   gums, such as for example xanthan gum,
   algae extracts such as alginates and carrageenas, or
   a combination of these various stabilizers-thickeners,
emulsifiers, such as for example:
   lecithin, or
   fatty acid mono- and diglycerides, or
   diacetyltartaric esters of fatty acid mono- and diglycerides, and the like, or alternatively
   a combination of one or more emulsifiers such as those cited above,
enzymes, such as for example:
   amylases, and in particular alpha-amylases, including for example maltogenic alpha-amylases or other antistaling alpha-amylases,
   hemicellulases, and in particular xylanases,
   glucose oxidases,
   amyloglucosidases,
   phospholipases, and the like, or
   combinations of the said enzymes,
and cereal flours, or other ingredients characteristic of the composition of special breads.

The improver may also comprise other food ingredients, and in particular such water-soluble food ingredients used in baking and in particular those which have a baking improver effect. Examples of such a food ingredient are L-cysteine monohydrochloride and calcium chloride. Preferably, the improver according to the invention will comprise all the oxidants of the dough, optionally all the reducers of the dough, all the enzymatic preparations necessary for the type of baking envisaged, whether involving the manufacture, regardless of the process, of bread, “viennoiseries”, brioches, and in general of any fermented dough.

The improver may also comprise one or more other ingredients not specified above.

In the present context, the terms “bread making”, “baking” and “baker” should be interpreted broadly as referring to the baking and “viennoiseries” sectors, and in general to the sector for the production of products baked in the oven from fermented doughs based on cereal flour. More precisely, the doughs are fermented by yeasts. This excludes the products obtained by chemical leavening agents.

The present invention also relates to a dough comprising the improver according to the invention, and the baked product resulting therefrom. The dough into which the improver according to the invention is incorporated contains baker's yeast as fermentation agent. In this case, the dough is subjected to a step of fermentation with baker's yeast.

Thus, the present invention relates to a process for preparing a baker's dough for baking with ingredients comprising at least unfermented flour, water, bread-making yeast, comprising the incorporation of an improver according to the invention into the dough.

The preparation of a baker's dough ready for baking in the oven is a process comprising several steps, including at least one kneading step and at least one fermentation step. Preferably, the components of the improver according to the invention are incorporated into the dough before or during the kneading step, preferably before or at the beginning of the kneading step.

The water for the dough may be incorporated into the dough as such or partially or completely in the form of a mixture with other ingredients or in the form of a high moisture ingredient such as, for example, milk.

The invention therefore relates to a process for preparing dough for a bakery product comprising the addition of GDL and acid and/or acid salt, preferably acid preferment, to the other ingredients of the dough. By virtue of the present invention, the baker now has a dough for a bakery product comprising:
unfermented cereal flour,
bread-making yeast, that is to say active yeast,
an acid and/or acid salt, preferably an acid preferment, and
GDL,
   the acid and/or acid salt and the GDL of this dough being as defined above in relation to the improver according to the invention.

Bread-making yeast is by definition the active or live yeast which will enable the fermentation of the dough.

According to the invention, the dough for a bakery product may in particular be prepared according to the so-called straight dough processes, or sponge and dough, no-time dough processes or by any other baking process.

According to the invention and in accordance with practice, the expression sponge and dough process will be understood to mean a method of manufacturing bread, in which a first step consists in mixing water, part of the flour, and usually all the bread-making yeast and the nutritive ingredients useful for the yeast, thus making a sponge. This mixture is then left to ferment until it is judged ready to be used for preparing the dough by incorporating the other ingredients of the bread (definition extracted from the book “Glossary of Milling and Baking terms”, Samuel A. Matz, Pan-tech International, 1993).

More generally, the improver and the processes according to the invention using this improver are useful for the production of doughs or baked bakery products, in particular common bread, that is to say bread containing neither fat nor added sugar, for the production of sandwich bread, “viennoiseries”, brioches, special breads, and in general, for the production of all breads of the uncommon type containing fat and/or added sugar. Thus, the improver and the processes according to the invention are also suitable for the production of dough or baked products as manufactured for example in the United States of America, that is to say preferably containing a quantity of added sugar varying from 0.5 to 16% as dry matter content as baker's percentages and/or a quantity of added fat, for example oil, varying from 0.5 to 10% as baker's percentage and in particular those obtained by the sponge and dough or no-time dough process.

In particular, the invention relates to a process for the preparation of baked products comprising:
the preparation of a dough containing unfermented flour, water, bread-making yeast, and comprising the incorporation of an improver according to the present invention into the dough,
the fermentation of the dough, and
the baking of the raised dough with production of a baked product,

the said process optionally comprising laminating the dough between the steps of preparation and fermentation.

In a particular embodiment of the process, the baked product may be sliced and/or wrapped. Preferably, the baked product is selected from the group consisting of French-type bread, sandwich bread, “viennoiseries”, brioches and special breads.

The invention also relates to the baker's doughs obtained by or capable of being obtained by the processes for producing a baked bakery product in which such a baker's dough is baked in the oven.

The invention also allows the baker to make baked products of good quality with doughs comprising unfermented cereal flour, bread-making yeast, an acid preferment and GDL.

The dough may be a fermented dough, preferably chosen from the group comprising bread doughs, brioche doughs or “viennoiseries” doughs, it being possible for such doughs to be used in the context of straight dough, parbaked dough or frozen dough technologies.

According to a preferred embodiment, the invention relates in particular to such frozen raw doughs.

According to a particularly preferred embodiment, the invention also relates to parbaked doughs, or to frozen parbaked doughs, which may be obtained by fermentation, parbaking and freezing of a dough according to the invention.

Thus, the invention relates to a process for the preparation of frozen parbaked products comprising:
the preparation of a dough comprising unfermented flour, water, bread-making yeast, into which GDL has been incorporated and an acid and/or acid salt, preferably an acid preferment, in particular an improver according to the invention,
the fermentation of the dough,
the partial baking of the raised dough with production of a parbaked product, and
the freezing of the parbaked product,

the said process optionally comprising laminating the dough between the steps of preparation and fermentation.

The invention also relates to the baked bakery products which can be obtained by fermentation and baking of a dough according to the invention, it being possible for these baked products to be in particular breads, preferably baguettes, sandwich breads, “viennoiseries” and/or brioches.

The advantages of the present invention are illustrated in the comparative hereinbelow example which is of course not limiting.

### EXAMPLE 1

The benefit of the invention is illustrated by a study using the Brabender extensograph. This test consists in stretching a cylindrical piece of dough containing no yeast until it breaks. A measurement of the resistance to stretching is made during the whole experiment.

### Protocol

Kneading
1. Preliminary determination of the absorptive power of the flour (AFNOR method No. V30-171/1).
2. Start the water bath about 30 minutes before the first kneading (until the reference temperature 30° C. is obtained).
3. Cylindrical dough formula:
   Flour: 300 g equivalent at 14% moisture
   Water: add the quantity of water necessary to reach 500 farinograph units (FU) at the end of the kneading.
   Salt: 6 g
4. Place the flour, the salt and any of the formulas according to the invention in the tank of the kneader.
5. Start the chronometer at the same time that the water starts to be introduced.
6. Kneading in the Brabender farinograph at speed 2 for 1 minute.
7. Rest: 5 min.
8. Kneading: 8 min.
9. The final consistency should be 500 FU: if this is not the case, modify the quantity of water accordingly and repeat step 2.

Preparation of the Samples
9. Weigh 2 samples of 150±0.1 g of dough.
10. Place in the rounder and count 20 revolutions.
11. Place the dough delicately in the moulder.
12. When the dough piece leaves the moulder, start the chronometer counting the rest time.
13. Place the dough cylinder obtained on a slightly greased support and grip it with the top part.
14. Store in a humid chamber regulated at 30° C.

Extension Test
15. After a rest period of 20 min, place the sample on the arm of the extensograph.
16. Adjust the position of the recorder so that it is on the zero line with the screw placed on the recorder.
17. At t₂₀ₘᵢₙᵤₜₑₛ exactly, start the movement of the hook, and stop it when the dough cylinder breaks.
18. Reshape the dough (rounding-moulding) and store it again for 45 min.
19. Repeat step 17 for the second dough piece.
20. At t₆₅: the same as at t₂₀ (repeat step 17).
21. At t₁₁₀: the same as at t₂₀ (repeat step 17).

The Brabender extensograph provides mainly 2 values:
the maximum resistance before breaking of the dough, expressed as a specific unit (E.U.),
the maximum extension before breaking of the dough, expressed in mm.

Nature of the Samples

Two compositions according to the invention were tested.

### Test 1:

Formula A: 2% dry leaven+0.5% GDL

This composition was compared to formulas containing only dry leaven, or a combination of dry leaven and lactic acid. The alternative compositions B and C were formulated so as to reach the same pH at the end of proofing (end of kneading+2 hours).
Formula B: 3.5% dry leaven
Formula C: 2% dry leaven+0.2% lactic acid

In order to approach baking conditions, the doughs prepared with the alternative formulas were made at a constant consistency (and not at constant hydration) measured on the farinograph.

Finally, in order to have a comparative component, the experiments were performed on a control dough without any addition (=formula D).

### Test 2:

Formula A′: 2% dry leaven+1% GDL
Formula B′: 5% dry leaven
Formula C′: 2% dry leaven+0.4% lactic acid
Formula D′: dough with no addition

Results

Comparison of formulas A, B, C, and D = Test 1

| Formula | A | B | C | D |
|---|---|---|---|---|
| Resistance at 20 min (E.U.) | 847 | >1000 | >1000 | 530 |
| Resistance at 65 min | >1000 | >1000 | >1000 | 540 |
| Resistance at 110 min | >1000 | >1000 | >1000 | 600 |
| Extensibility at 20 min (mm) | 101 | 76 | 84 | 146 |
| Extensibility at 65 min | 86 | 69.5 | 70 | 153 |
| Extensibility at 110 min | 78 | 63 | 71 | 132 |

Comparison of formulas A′, B′, C′ and D′ = Test 2

| Formula | A′ | B′ | C′ | D′ |
|---|---|---|---|---|
| Resistance at 20 min (E.U.) | 857 | >1000 | >1000 | 530 |
| Resistance at 65 min | >1000 | >1000 | >1000 | 540 |
| Resistance at 110 min | >1000 | >1000 | >1000 | 600 |
| Extensibility at 20 min (mm) | 100 | 64.5 | 59 | 146 |
| Extensibility at 65 min | 86 | 55.5 | 63 | 153 |
| Extensibility at 110 min | 66 | 58.5 | 58 | 132 |

The resistance of the dough is an indication, on the one hand, of the maximum force to be applied in order to extend the dough, and, on the other hand, of the resistance to gaseous pressure. In other words, the higher the resistance, the higher the resistance to pressure and, consequently, the lower the volume of the breads. This resistance is lower for formula A according to the invention containing a dry leaven and GDL than for the combinations leaven alone (B) and leaven+lactic acid (C). This perfectly demonstrates that the addition of GDL to the dry leaven makes it possible to significantly reduce the rheological disadvantages linked to the use of leaven, by reducing, on the one hand, the resistance of the dough.

On the other hand, the rheological benefits linked to the use of GDL in combination with a leaven can also be measured by virtue of the extensibility. The extensibility is the maximum extension of the dough before breaking. The higher the extensibility, the more the shaping will be facilitated. The dough made with a combination of leaven and GDL (A) has a much better extensibility than that made with leaven alone (B) or leaven in combination with lactic acid (C).

The same positive conclusions on the use of GDL in combination with dry leaven may be made for test 2.

1. Baking improver comprising an acid preferment and glucono-delta-lactone (GDL).

2. Baking improver according to claim 1, characterized in that it contains, as baker's percentage, between 0.05 and 5% of GDL, preferably still between 0.1 and 3% and preferably still between 0.1 and 1.5%.

3. Baking improver according to claim 1, characterized in that the acid preferment is a dry, pasty or liquid leaven.

4. Baking improver according to claim 3, characterized in that the acid preferment is a dry leaven.

5. Improver according to claim 1, characterized in that the improver has a dry matter content of at least 85%, preferably greater than or equal to 90% by mass and preferably still greater than or equal to 94% by mass.

6. Improver according to claim 5, characterized in that the improver is solid, in particular in pulverulent or granular form.

7. Improver according claim 1, characterized in that it is liquid.

8. Improver according to claim 1, characterized in that it is pasty, semi-moist or semi-liquid.

9. Improver according to claim 1, characterized in that the glucono-delta-lactone is packaged in the form of a mixture with the acid preferment.

10. Improver according to claim 1, characterized in that the glucono-delta-lactone is packaged separately from the acid preferment.

11. Improver according to claim 10, characterized in that the glucono-delta-lactone is encapsulated.

12. Improver according to claim 1, characterized in that the acid preferment comprises at least one component selected from the group consisting of lactic acid, lactic acid salts, acetic acid, acetic acid salts, propionic acid, propionic acid salts, benzoic acid, benzoic acid salts, sorbic acid and dietary salts of sorbic acid, malic acid, malic acid salts, citric acid, citric acid salts, ascorbic acid, ascorbic acid salts, alginic acid, alginic acid salts and combinations thereof.

13. Improver according to claim 12, characterized in that the acid preferment comprises at least one component chosen from the group consisting of lactic acid, lactic acid salts, acetic acid, acetic acid salts and combinations thereof.

14. Improver according to claim 1, also comprising one or more ingredients chosen from the group consisting of ascorbic acid, L-cysteine or deactivated yeast, emulsifiers, stabilizers/thickeners and enzymes.

15. Process for preparing a baker's dough for baking with ingredients comprising at least unfermented flour, water, bread-making yeast, characterized in that it comprises the incorporation of an improver according to claim 1 into the dough.

16. Process for the preparation of baked products comprising:
the preparation of a dough comprising unfermented flour, water, bread-making yeast, into which an improver according to claim 1 has been incorporated,
the fermentation of the dough, and
the baking of the raised dough with production of a baked product,
the said process optionally comprising laminating the dough between the steps of preparation and fermentation.

17. Process according to claim 16, in which the baked product is sliced.

18. Process according to claim 16, in which the product is wrapped.

19. Process according to claim 16, in which the baked product is selected from the group consisting of breads of the common type and breads of the uncommon type, in particular sandwich bread, “viennoiseries”, brioches, and special breads.

20. (canceled)

21. Process for the preparation of frozen parbaked products comprising:
the preparation of a dough containing unfermented flour, water, bread-making yeast, into which an improver according to claim 1 has been incorporated,
the fermentation of the dough,
the partial baking of the raised dough with production of a parbaked product, and
the freezing of the parbaked product,
the said process optionally comprising laminating the dough between the steps of preparation and fermentation.

22. Dough comprising an improver according to claim 1.

23. Combination comprising an acid preferment and glucono-delta-lactone used simultaneously or separately over time as baking improver.
